(19) United States
(12) Patent Application Publication
(10) Pub. No.: US 2013/0325212 A1
(43) Pub. Date: Dec. 5, 2013

(54) AERIAL VEHICLE WITH MISSION DURATION CAPABILITY DETERMINATION

(71) Applicant: David L. Wickman, Sandy Hook, CT (US)

(72) Inventor: David L. Wickman, Sandy Hook, CT (US)

(73) Assignee: UNITED TECHNOLOGIES CORPORATION, Hartford, CT (US)

(21) Appl. No.: 13/482,477

(22) Filed: May 29, 2012

(51) Int. Cl. B64D 45/00; F01D 25/18

(52) U.S. Cl. 701/3

(57) ABSTRACT

An aerial vehicle can include oil sensors connected to a lubrication system and a computer connected to the oil sensors. The computer can be programmed to determine mission duration for the unmanned aerial vehicle, determine a maximum oil system duration for the unmanned aerial vehicle based upon data from the oil sensors, perform a comparison of the mission duration to the maximum oil system duration, and output a signal based upon the comparison.

### BACKGROUND

The present invention relates to aerial vehicles and in particular, to lubrication systems on aerial vehicles. Aerial vehicles typically include some type of engine for propulsion, such as a gas turbine engine. Such aerial vehicles typically require fuel, air, and oil to operate. If the aerial vehicle is starved for any one of fuel, air, or oil, its engine will not operate, possibly resulting in catastrophic failure.

Manned aerial vehicles, such as certain military aircraft, are typically used on missions that have a mission duration that is compatible with a human crew's ability to effectively perform the mission. Typical mission durations for manned aerial vehicles can be about 3 hours, and are usually less than 10 hours. An unmanned aerial vehicle (UAV) (commonly referred to as a “drone” or an “autonomous flight vehicle”) does not include a human pilot or crew aboard the UAV. Therefore, UAVs are not limited to missions that have a mission duration that is compatible with a human crew's ability to effectively perform the mission. Consequently, UAVs can be used for missions with relatively long mission durations. However, extended mission durations can create new challenges for UAVs.

### SUMMARY

According to the present invention, an aerial vehicle can include oil sensors connected to a lubrication system and a computer connected to the oil sensors. The computer can be programmed to determine mission duration for the unmanned aerial vehicle, determine a maximum oil system duration for the unmanned aerial vehicle based upon data from the oil sensors, perform a comparison of the mission duration to the maximum oil system duration, and output a signal based upon the comparison.

Another embodiment of the present invention is a method for operating an aerial vehicle. The method can include determining a mission duration for the aerial vehicle, determining a maximum oil system duration for the aerial vehicle based upon data from oil sensors, performing a comparison of the mission duration to the maximum oil system duration via a computer and outputting a signal from the computer based upon the comparison.

### BRIEF DESCRIPTION OF THE DRAWINGS

FIG. 1 is a schematic view of an unmanned aerial vehicle.

FIG. 2 is a flow chart of a method of operating the unmanned aerial vehicle of FIG. 1.

### DETAILED DESCRIPTION

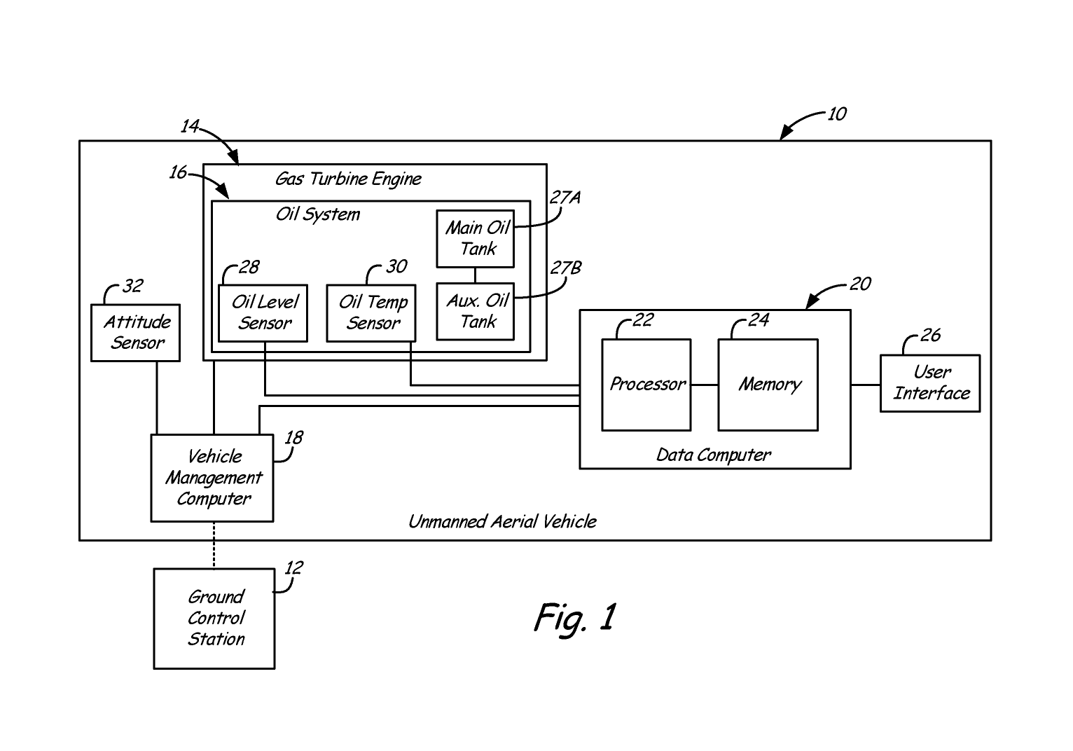

FIG. 1 is schematic view of unmanned aerial vehicle (UAV) 10 and ground control station 12. UAV 10 includes gas turbine engine 14 (which includes oil system 16), vehicle management computer 18, data computer 20 (which includes processor 22 and memory 24), and user interface 26. Gas turbine engine 14 can be a propulsion engine, such as a turbofan or turboprop engine, with one or more compressor stages, combustors, and turbine stages (not shown). Gas turbine engine 14 can include various components such as gears and bearings (not shown) that benefit from having a substantially continuous supply of lubricating liquid, such as oil. Oil system 16 supplies oil to and scavenges oil from the components of gas turbine engine 14. In the illustrated embodiment, oil system 16 can include main oil tank 27A which is fluidically connected to auxiliary oil tank 27B. Oil system 16 can also include one or more supply pumps, scavenge pumps, filters, valves, connection passages, and/or other features (not shown). Oil system 16 can also include various sensors, such as oil level sensor 28 and oil temperature sensor 30. Oil level sensor 28 can measure a level of oil in one or more portions of oil system 16, such as one or more reservoirs. Oil temperature sensor 30 can measure temperature of oil in one or more portions of oil system 16, such as in one or more reservoirs and/or connection passages.

Gas turbine engine 14 is connected to and controlled by vehicle management computer 18. Vehicle management computer 18 controls operation of substantially all components of UAV 10, including gas turbine engine 14. Vehicle management computer 18 receives flight data from various sensors, including aircraft attitude sensor 32. Aircraft attitude sensor 32 determines attitude, including pitch, roll, and yaw of UAV 10, and sends attitude data to vehicle management computer 18. Vehicle management computer 18 receives signals wirelessly from ground control station 12. One or more operators, such as a flight crew, control operation of UAV 10 via ground control station 12, which communicates a mission plan and/or other information to vehicle management computer 18 of UAV 10.

Data computer 20 is connected to vehicle management computer 18 and receives flight data from vehicle management computer 18, such as attitude data. Data computer 20 is also connected to and receives data from various sensors such as oil level sensor 28 and oil temperature sensor 30. Data computer 20 can also be connected to user interface 26, for receiving user inputs from user interface 26 and/or for outputting signals to user interface 26. User interface 26 can be integrated with UAV 10 or can be an external component connected via a wire or wirelessly to UAV 10. Data computer 20 can store data from vehicle management computer 18, user interface 26, oil level sensor 28, oil temperature sensor 30, and aircraft attitude sensor 32 in memory 24. Memory 24 can be an electronic, optical, magnetic, or other computer readable media capable of providing a computer, such as data computer 20, with computer-readable instructions, such as a floppy disk, CD-ROM, DVD, magnetic disk, memory chip, ROM, RAM, an ASIC, a configured processor, magnetic tape, or any other media from which a computer can read instructions. Data computer 20 can process data in processor 22. Data computer 20 can be programmed to determine mission duration for UAV 10, determine a maximum oil system duration for UAV 10 based upon data received from the various sensors, perform a comparison of the mission duration to the maximum oil system duration, and output a signal based upon the comparison. Data computer 20 can output the signal to user interface 26 and/or ground control station 12 via vehicle management computer 18.

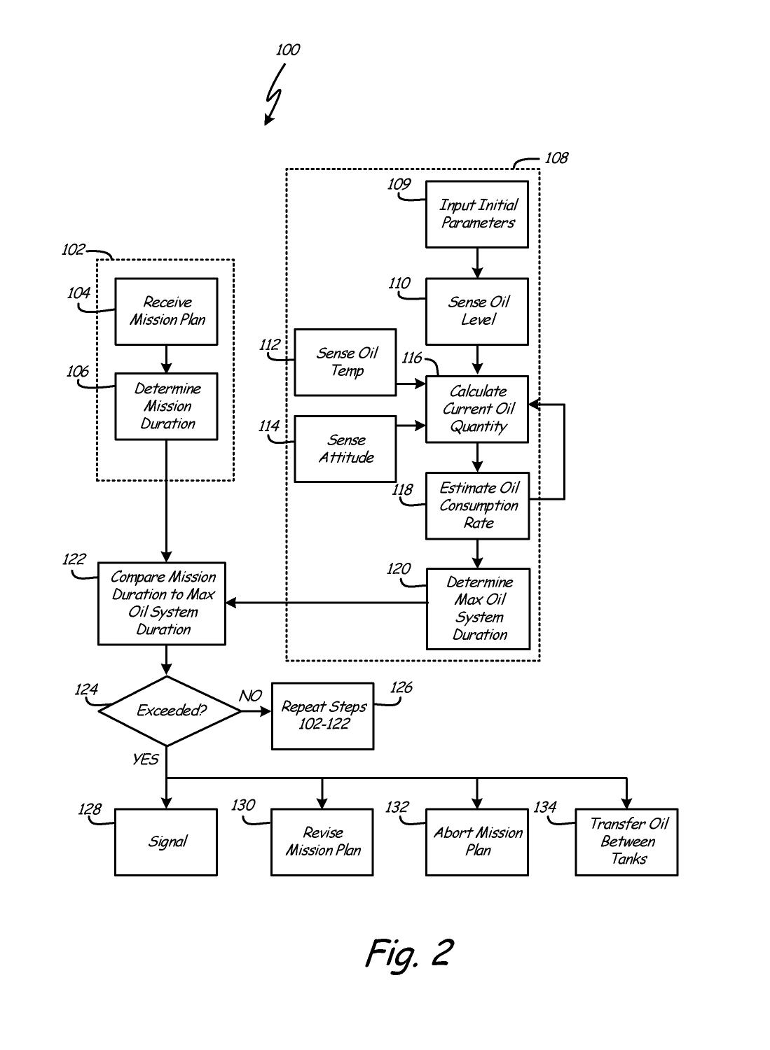

FIG. 2 is a flow chart of method 100 for operating UAV 10 (shown in FIG. 1). Memory 24 can store instructions for performing some or all of the following steps. Step 102 is to determine a mission duration for UAV 10. Mission duration for UAV 10 can extend over several days. For example, in one embodiment of UAV 10, the mission duration can exceed 100 hours. Step 102 includes sub-steps 104 and 106. In sub-step 104, vehicle management computer 18 receives a mission plan from ground control station 12. Alternatively, the mission plan could be received from user interface 26. In sub-step 106, vehicle management computer 18 transmits data regarding the mission plan that is sufficient to determine a mission duration to data computer 20. Such data can include transmitting the entire mission plan or transmitting an amount of time in days, hours, minutes, and/or seconds. Data computer 20 then determines the mission duration and stores the mission duration in memory 24. Data computer 20 can determine both the total mission duration and, for an active mission where UAV 10 is currently in flight, a remaining mission duration.

Step 108 is to determine a maximum oil system duration for UAV 10. Step 108 includes sub-steps 109, 110, 112, 114, 116, 118, and 120. In sub-step 109, initial parameters are inputted to data computer 20. This can include setting a minimum quantity of oil retained in oil system 16. This can also include setting a reserve mission duration that is based on the minimum quantity of oil. The reserve mission duration is a length of time that UAV 10 can be expected to operate in excess of the mission duration of the mission plan. In sub-step 110, oil level sensor 28 senses oil level in oil system 16 and transmits oil level data to data computer 20. Sensed oil level does not always accurately correspond to actual oil quantity, as the sensed oil level can be affected by oil temperature and attitude of UAV 10. Changes in oil temperature can cause changes in oil density, and therefore, oil volume. Changes in attitude can cause oil in a reservoir to slosh toward and away from oil level sensor 28. In sub-step 112, oil temperature sensor 30 senses oil temperature in oil system 16 and transmits oil temperature data to data computer 20. Data computer 20 can use the oil temperature data to calculate oil density and oil volume for use in calculation of oil quantity. In sub-step 114, attitude sensor 32 senses attitude of UAV 10 and oil system 16 and transmits attitude data to data computer 20.

In sub-step 116, data computer 20 calculates a current oil quantity based on the sensed oil level data, oil temperature data, and attitude data. In one embodiment, data computer 20 can use attitude data to adjust its calculation of the current oil quantity for pitch, roll, and/or yaw. In another embodiment, data computer 20 can use the attitude data to determine whether to calculate oil quantity at all. For example, data computer 20 need not calculate the current oil quantity during take-off. Data computer 20 can calculate current oil quantity based upon sensed oil level only when attitude data is in a predetermined range, and can null sensed measurements and calculations when attitude data is outside of the predetermine range or when certain take-off or landing gear (not shown) are in a take-off or landing position. One suitable time for sensing oil level and temperature and calculating current oil quantity is during engine idle while UAV 10 is on the ground prior to take-off or after landing and before shut-down. Other suitable times occur when UAV 10 is in flight. Depending on the application, data computer 20 can include more or less data from additional or fewer sensors as is suitable for that application. Sub-step 116 can be repeated over a plurality of flight cycles. Flight cycles can be relatively short, such as between 0.1 second and 1.0 seconds. Alternatively, flight cycles can be longer, such that current oil quantity is calculated based on the sensed oil level data, oil temperature data, and attitude data only at designated waypoints along the mission.

In sub-step 118, data computer 20 then estimates an oil consumption rate based upon the current oil quantity calculated over the plurality of flight cycles. Oil consumption rate can vary substantially in oil system 16, for example, if oil system 16 begins to leak or if gas turbine engine 14 starts to consume oil at a higher rate due to wear of components in gas turbine engine 14. Sub-step 118 can repeatedly loop back to sub-step 116 so as to continuously update the oil consumption rate. This can allow data computer 20 to avoid using an outdated and potentially inaccurate oil consumption rate in its calculations. Thus, data computer 20 need not be programmed with a baseline oil consumption rate, since data computer 20 calculates the oil consumption rate real-time. The oil consumption rate can be calculated over the course of an entire mission, or over the course of a segment of the mission between waypoints. In sub-step 120, data computer 20 can estimate an amount of time until the current oil quantity drops below a threshold. Data computer 20 can perform this estimate based upon the current oil consumption rate or a combination of the current oil consumption rate with historical oil consumption rates. Data computer 20 can set a maximum oil system duration for UAV 10 to be equal to the estimated amount of time, or can set the maximum oil system duration for UAV 10 based upon (but not directly equal to) the estimated amount of time. The maximum oil system duration can be adjusted to account for the reserve mission duration set in sub-step 109.

In step 122, data computer 20 can perform a comparison of the mission duration to the maximum oil system duration. If the mission duration does not exceed the maximum oil system duration (decision step 124) , then step 126 can be performed, which is to repeat some or all of steps 102 to 122 to continuously update data and calculations. If the mission duration does exceed the maximum oil system duration (decision step 124), then one or more of steps 128, 130, 132, and 134 can be performed. Steps 128, 130, 132, and 134 can be performed by data computer 20, vehicle management computer 18, or both in combination.

In step 128, data computer 20 can output a signal based on the comparison of step 124. Data computer 20 and/or vehicle management computer 18 can output an alarm, such as a text warning that the mission duration exceeds the maximum oil system duration. The signal can be outputted to vehicle management computer 18, ground control station 12, and/or user interface 26. In one embodiment, the signal can be outputted to ground control station 12 so as to notify ground control station 12 that the reserve mission duration, set in sub-step 109, has been exceeded.

In step 130, data computer 20 and/or vehicle management computer 18 can revise the mission plan to have a shorter revised mission duration in response to the mission duration exceeding the maximum oil system duration. For example, the mission plan can be revised to omit a waypoint from the original mission plan. Data computer 20 and/or vehicle management computer 18 can determine which waypoint or waypoints to omit based upon data in the original mission plan or based upon data learned during the mission.

In step 132, data computer 20 and/or vehicle management computer 18 can abort the mission plan. If step 122 is performed prior to the mission while UAV 10 is still on the ground, then aborting the mission plan can cause UAV 10 to not even begin the mission plan. If step 122 is performed after UAV 10 has already commenced the mission plan, then aborting the mission plan can cause UAV 10 to return directly to a base. This can occur, for example, when oil system 16 develops a leak in flight, such that the mission duration did not exceed the maximum oil system duration at take-off but did exceed the maximum oil system duration subsequently during the mission plan.

In step 134, data computer 20 and/or vehicle management computer 18 can signal oil system 16 to transfer oil from auxiliary oil tank 27B to main oil tank 27A in response to the mission duration exceeding the maximum oil system duration.

UAV 10 and the above-described method can effectively determine mission duration capability for oil system 16 of UAV 10. This can allow a user to avoid launching UAV 10 on a mission for which oil system 16 is not currently capable of performing. The user can respond by adding oil to oil system 16, repairing oil system 16 or another component on UAV 10, or using an alternate unmanned aerial vehicle for that particular mission, while using UAV 10 for another mission of shorter duration. This can also allow UAV 10 to determine mid-mission that a change in circumstances has occurred that has caused UAV 10 to be unable to perform the full mission. UAV 10 can then return to base or automatically recalculate a revised mission that UAV 10 is still capable of performing. This can help prevent sensitive technology on UAV 10 from falling into enemy hands due to a failure of lubrication 16 at an unexpected time. This can also allow UAV 10 to perform missions of long duration, which conventional manned aircraft may not have needed to or been capable of performing. Such long missions can be undertaken while limiting fear of an unexpected and catastrophic failure of lubrication system 16 and UAV 10.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, the functions performed by vehicle management computer 18 and data computer 20 can be performed by a single computer or can be performed by more than two computers.

1. An unmanned aerial vehicle comprising:
a gas turbine engine;
a lubrication system connected to the gas turbine engine;
oil sensors connected to the lubrication system; and
a computer connected to the oil sensors and programmed to determine mission duration for the unmanned aerial vehicle, determine a maximum oil system duration for the unmanned aerial vehicle based upon data from the oil sensors, perform a comparison of the mission duration to the maximum oil system duration, and output a signal based upon the comparison.

2. The unmanned aerial vehicle of claim 1, wherein the oil sensors comprise an oil level sensor and an oil temperature sensor, the unmanned aerial vehicle further comprising:
an aircraft attitude sensor connected to the computer for determining attitude data of the unmanned aerial vehicle, wherein the computer is programmed to determine the maximum oil system duration for the unmanned aerial vehicle only when the attitude data is in a predetermined range.

3. The unmanned aerial vehicle of claim 1, wherein the computer is a data computer, the unmanned aerial vehicle further comprising:
a vehicle management computer connected to the gas turbine engine for controlling the gas turbine engine based upon information received wirelessly from a ground control station.

4. Computer readable media for storing instruction for operating an aerial vehicle, comprising:
instructions to determine a mission duration for the aerial vehicle;
instructions to determine a maximum oil system duration for the aerial vehicle based upon data from oil sensors;
instructions to perform a comparison of the mission duration to the maximum oil system duration; and
instructions to output a signal based upon the comparison.

5. The computer readable media of claim 4, and further comprising:
instructions for revising a mission plan to have a shorter revised mission duration in response to the mission duration exceeding the maximum oil system duration.

6. The computer readable media of claim 4, and further comprising:
instructions for aborting a mission plan in response to the mission duration exceeding the maximum oil system duration.

7. The computer readable media of claim 4, wherein the instructions to determine a maximum oil system duration for the aerial vehicle comprise:
instructions for sensing oil level in an oil system of a gas turbine engine of the aerial vehicle via an oil level sensor;
instructions for sensing oil temperature in the oil system via an oil temperature sensor;
instructions for sensing attitude of the aerial vehicle via an aircraft attitude sensor;
instructions for calculating a current oil quantity based upon sensed oil level, oil temperature, and attitude over a plurality of cycles;
instructions for estimating oil consumption rate based upon the current oil quantity calculated over the plurality of cycles; and
instructions for estimating an amount of time until the current oil quantity drops below a threshold based upon the oil consumption rate and the current oil quantity.

8. The computer readable media of claim 4, wherein the instructions to determine a maximum oil system duration for the aerial vehicle further comprise:
instructions for continuously updating the amount of time until the current oil quantity drops below the threshold at each of the plurality of cycles during flight.

9. The computer readable media of claim 8, wherein the plurality of cycles are spaced by between 0.1 second and 1.0 second.

10. A method for operating an aerial vehicle, the method comprising:
determining a mission duration for the aerial vehicle;
determining a maximum oil system duration for the aerial vehicle based upon data from oil sensors;
performing a comparison of the mission duration to the maximum oil system duration via a computer; and
outputting a signal from the computer based upon the comparison.

11. The method of claim 10, and further comprising:
revising a mission plan to have a shorter revised mission duration in response to the mission duration exceeding the maximum oil system duration.

12. The method of claim 10, and further comprising:
aborting a mission plan in response to the mission duration exceeding the maximum oil system duration.

13. The method of claim 10, wherein the aerial vehicle is an unmanned aerial vehicle and wherein the mission duration exceeds 100 hours.

14. The method of claim 10, wherein the signal comprises an alarm in the form of a text warning that the mission duration exceeds the maximum oil system duration.

15. The method of claim 10, wherein determining a maximum oil system duration for the aerial vehicle comprises:
sensing oil level in an oil system of a gas turbine engine of the aerial vehicle via an oil level sensor;
sensing oil temperature in the oil system via an oil temperature sensor;
sensing attitude of the aerial vehicle via an aircraft attitude sensor;
calculating a current oil quantity based upon sensed oil level, oil temperature, and attitude over a plurality of cycles;
estimating oil consumption rate based upon the current oil quantity calculated over the plurality of cycles; and
estimating an amount of time until the current oil quantity drops below a threshold based upon the oil consumption rate and the current oil quantity.

16. The method of claim 15, wherein determining a maximum oil system duration for the aerial vehicle further comprises:
continuously updating the amount of time until the current oil quantity drops below the threshold at each of the plurality of cycles during flight.

17. The method of claim 16, wherein the plurality of cycles are spaced by between 0.1 second and 1.0 second.

18. The method of claim 10, wherein performing a comparison of the mission duration to the maximum oil system duration and outputting a signal occur prior to the aerial vehicle embarking on a mission plan.

19. The method of claim 10, wherein performing a comparison of the mission duration to the maximum oil system duration and outputting a signal occur after the aerial vehicle embarks on a mission plan.

20. The method of claim 15, wherein the aerial vehicle is an unmanned aerial vehicle and further comprises:
controlling the unmanned aerial vehicle via a vehicle management computer based upon information received wirelessly from a ground control station.

21. The method of claim 10, and further comprising:
setting a reserve mission duration to a length of time that the aerial vehicle can be expected to operate in excess of the mission duration.

22. The method of claim 21, wherein outputting a signal comprises:
notifying a ground control station that the reserve mission duration has been exceeded.

23. The method of claim 10, and further comprising:
transferring oil from an auxiliary oil tank to a main oil tank in response to the mission duration exceeding the maximum oil system duration.
